(19) United States
(12) Patent Application Publication
(10) Pub. No.: US 2004/0071534 A1
(43) Pub. Date: Apr. 15, 2004

(54) Adjustable wafer alignment arm

(75) Inventor: Willard Charles Raymond, Plymouth, MN (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(73) Assignee: August Technology Corp.

(21) Appl. No.: 10/622,850

(22) Filed: Jul. 18, 2003

Related U.S. Application Data
(60) Provisional application No. 60/397,356, filed on Jul. 18, 2002.

(51) Int. Cl. B65G 65/04

(52) U.S. Cl. 414/416.01

(57) ABSTRACT

A wafer handler for semiconductors or like substrates for significantly reduces alignment problems by reducing or eliminating sagging in large diameter wafers such as 300 mm wafers.

### REFERENCE TO RELATED APPLICATION

This application claims the benefit of, and incorporates herein by reference an entirety of, U.S. Provisional Application No. 60/397,356, filed Jul. 18, 2002.

### BACKGROUND OF THE INVENTION

1. Technical Field

The present invention relates to handling of wafers.

2. Background Information

Over the past several decades, the microelectronics and semiconductor has exponentially grown in use and popularity. Microelectronics and semiconductors have in effect revolutionized society by introducing computers, electronic advances, and generally revolutionizing many previously difficult, expensive and/or time consuming mechanical processes into simplistic and quick electronic processes. This boom has been fueled by an insatiable desire by business and individuals for computers and electronics, and more particularly, faster, more advanced computers and electronics whether it be on an assembly line, on test equipment in a lab, on the personal computer at one's desk, or in the home via electronics and toys.

The manufacturers of microelectronics and semiconductors have made vast improvements in end product quality, speed and performance as well as in manufacturing process quality, speed and performance. However, there continues to be demand for faster, more reliable and higher performing semiconductors.

One process that has evolved over the past decade plus is the microelectronic and semiconductor inspection process. The merit in inspecting microelectronics and semiconductors throughout the manufacturing process is obvious in that bad wafers may be removed at the various steps rather than processed to completion only to find out a defect exists either by end inspection or by failure during use. In the beginning, wafers and like substrates were manually inspected such as by humans using microscopes. As the process has evolved, many different systems, devices, apparatus, and methods have been developed to automate this process such as the method developed by August. Technology Inc. of Bloomington, MN and disclosed in U.S. Pat. No. 6,324,298, the teachings of which are incorporated by reference. Many of these automated inspection systems, devices, apparatus, and methods focus on two dimensional inspection, that is inspection of wafers or substrates that are substantially or mostly planar in nature. Alternatively or in addition, automated wafer or substrate inspection systems provide three dimensional inspection, such as inspection of bumps or other three dimensional features.

Regardless, to perform such inspection, it is necessary to handle the wafers to be inspected. To this end, accepted wafer processing techniques entail formation thereof on a film that is otherwise supported about it periphery by a circular ring (or “film frame”). A number of these film frames are loaded within a “cassette” for transport between processing and inspection stations. The cassettes themselves are uniquely designed for receiving film frames, forming a series of spaced slots that are otherwise sized to receive individual ones of the film frames. The number of slots (and thus the number of loaded film frames) may vary for a particular cassette design. Further, the slots oftentimes extend at a slight downward angle (or pitch) relative to a front opening of the cassette so as to prevent unexpected forward movement of a loaded film frame from the cassette slot. A conventional cassette slot pitch is on the order of 0.39 inch. In any event, cassette loading normally occurs at a handling station having an end effector configured to grip individual film frames at an edge thereof, normally in a cantilevered fashion in an attempt to account for the pitch of the cassette slot. Once engaged, the end effector maneuvers the film frame to an available cassette slot, and inserts the film frame within the slot. This process is reversed to remove a loaded film frame from a cassette.

The above-described technique for loading/unloading film frame cassettes has been shown to be quite viable in the handling of many available film frames. By way of reference, conventional film frame (and thus wafer) diameters are 150 mm and 200 mm. More recently, however, wafers (and thus their associated film frames) have grown in diameter, such as up to the current standard of 300 mm, while remaining very thin in thickness. Handling of these larger diameter film frames, such as with the loading and/or unloading of cassettes, may be problematic with the known equipment described above. For example, the heavy wafer will often sag or bow in the middle when lifted at the edge of the film frame. Such sagging is undesirable and may lead to cassette loading/unloading problems and even wafer breakage. Further alignment complications, regardless of film frame diameter, may also arise due to the inconsistencies in cassette slot pitch, number of slots per cassette, etc.

### SUMMARY OF INVENTION

The handling of semiconductors or like substrates by the present invention significantly reduces alignment problems by reducing or eliminating sagging in large diameter wafers such as 300 mm wafers.

### BRIEF DESCRIPTION OF THE DRAWINGS

Preferred embodiment of the invention, illustrative of the best mode in which applicant has contemplated applying the principles, are set forth in the following description and are shown in the drawings and are particularly and distinctly pointed out and set forth in the appended claims.

FIG. 1 is a view of the present invention; and

FIG. 2 is an enlarged view of a portion of the present invention. Similar numerals refer to similar parts throughout the drawings.

### DETAILED DESCRIPTION OF THE PREFERRED EMBODIMENT

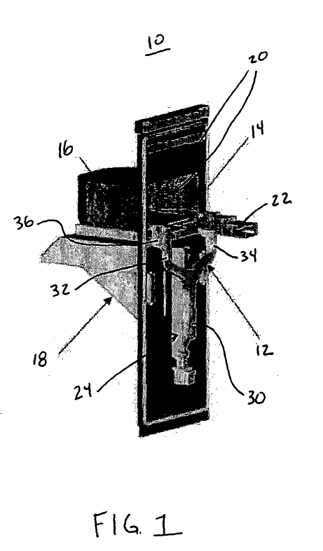

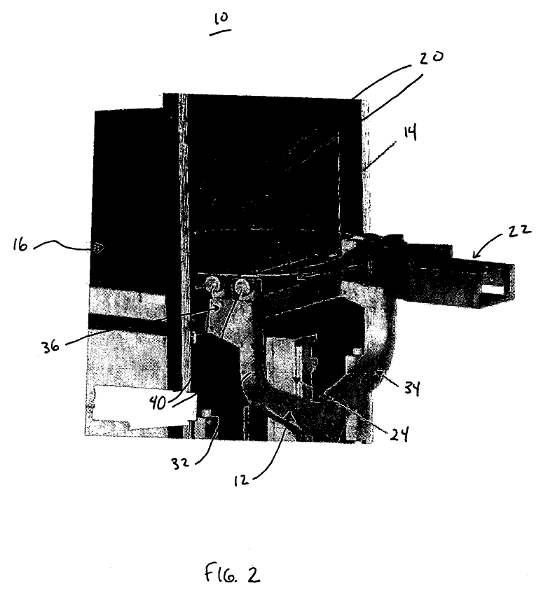

A handling system 10 in accordance with the present invention is best shown in FIG. 1. In accordance with one of the features of the invention, the handling system 10 includes a novel and unique Y-shaped frame support 12.

The handling system 10, and in particular the frame support 12, is adapted to handle and load/unload film frames 14 (one of which is shown in FIG. 1, it being noted that the film frame 14 does not include a formed wafer) to and from a cassette 16. The cassette 16 is maintained by a load port 18 of the handling system 10 at a fixed position relative to the frame support 12. To this end, the cassette 16 forms a plurality of slots 20 (referenced generally in FIG. 1) each sized to receive one cassette 16. With this in mind, the handling system 10 is adapted to handle a variety of differently sized film frames, such as 150 mm, 200 mm and 300 mm film frames. As a point of reference, when a 300 mm film frame is gripped from its edge, the size and mass of the frame causes a slight sag in the film stretched in between the ring-shaped frame. Due to a variety of factors, it is difficult to anticipate the actual amount of sag from film frame to film frame, although it is known that the typical pitch of a film frame cassette is 0.39″.

To help ensure proper placement of the film frames 14 into and out of the cassette 16, the frame support 12 in accordance with one of the features of the present invention is used in conjunction with a robotic end effector 22 and elevator mechanism 24. The end effector 22 can be of any type known in the art, and is adapted to grip the film frame 14 at an edge thereof, as provided with conventional film frame handling equipment. Preferably, the end effector 22 is mounted to the frame support 12, but alternatively can positioned to engage the film frame 14 apart from the frame support 12. Similarly, the elevator mechanism 24 can assume a variety of forms, and facilitates vertical movement of the frame support 12 and/or the end effector.

To overcome the deficiencies of prior handling systems, including eliminating possible sagging of the film frame 14 (or the wafer (not shown) maintained thereon) and facilitating proper alignment of the film frame 14 relative to the cassette 16, the Y-shaped frame support 12 is provided. The frame support 12 includes a substantially vertical base arm 30 and at least two support arms 32, 34 extending therefrom. As described in greater detail below, each of the support arms 32, 34 include adjustable feet 36 (referenced generally for the support arm 32 in FIG. 1) adapted to receive and support the film frame 14 and are adjustable to properly align with the film frame 14.

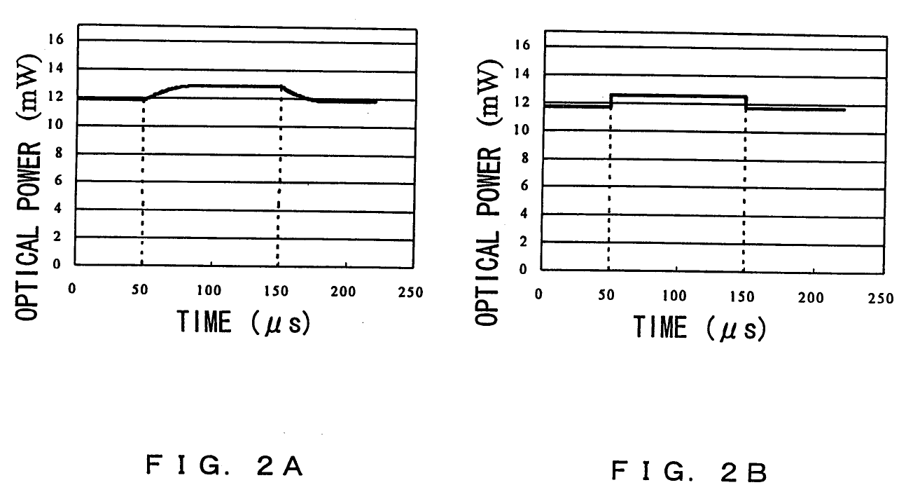

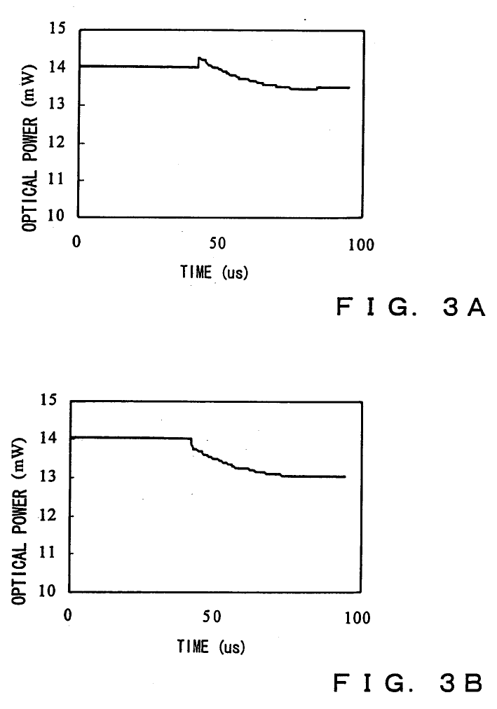

In one embodiment, the Y-shaped frame support 12 is linearly positioned using the elevator mechanism 24, which can include a servo motor. As best shown in FIG. 2, each of the feet 36 includes at least one, preferably a series, of contact elements 40. Where two or more contact elements 40 are provided for each of the support arms 32, 34, the contact elements 40 are slightly spaced from one another and are positioned to support the film frame 14 and compensate for any horizontal misalignment of the film frame 14 when gripped by a gripper in the robot end effector 22.

The contact elements 40 are mounted to the respective support arm 32 or 34 so as to be horizontally moveable (relative to the orientation of FIGS. 1 and 2). For example, the contact elements 40 are secured to or about a shaft that is otherwise extendably connected to the respective support arm 32 or 34. Alternatively, the contact elements 40 can be mounted to a support plate that is pivotally secured to the respective support arm 32 or 34. Regardless of the exact mounting technique, a programmable drive mechanism (unnumbered in the Figures) is connected to the component otherwise supporting the contact elements 40 and dictates a desired horizontal position of the rollers 40 relative to the base arm 30 and/or the support arms 32, 34. For example, a servo actuator can be provided that, upon activation, horizontally extends/retracts the contact elements 40 to the desired location that is otherwise dictated by a diameter of the film frame 14 being handled.

With the above in mind, the frame support 12 can be programmed to accommodate different cassette pitches and frame counts. In effect, the contact elements 40 are horizontally adjustable to accommodate film frame width, while the entire assembly 12 is vertically adjustable to assure that the contact elements 40 properly align and provide a smooth transition as the film frame 14 is pulled from or pushed back into a slot 20 in the cassette 16. Basically, the contact elements 40 provide a planar surface for the film frame 14 to roll out on to when the end effector 22 pulls the film frame 14 out of the cassette 16. This eliminates sag as the film frame 14 is not solely gripped in a cantilever fashion as in the prior art and instead is both gripped by the end effector 22 at the front edge of the film frame 14 (cantilever fashion) as well as supported along its outer underneath by the contact elements 40. This assures proper alignment during insertion of a film frame 14 into a slot 20 in the cassette 16, thus reducing the risks of mis-feed into the wrong slot, cross feed where opposite sides of the film frame 14 are not in planar slots, or the worst result where a wafer is broken because of resistance.

During use, a diameter of the film frame 14 is determined, and the handling system 10 is arranged to handle the film frame 14. For example, where it is determined that the film frame 14 has a diameter of 300 mm, the handling system 10 is arranged such that the contact elements 40 are properly positioned to contact the outer, bottom edge of a 300 mm diameter film frame 14. Arrangement of the contact elements 40 is preferably accomplished electronically, such as by programming of the actuator mechanism that otherwise dictates a horizontal position of the contact elements 40. Alternatively or in addition, the handling system 10 can be configured such that the contact elements 40 are manually positioned. Regardless, when a differently sized film frame 14 (e.g., a 200 mm diameter film frame) is subsequently processed (in connection with a differently-sized cassette), the contact elements 40 are readily horizontally re-positioned to accommodate the diameter of the new film frame.

In the embodiment shown in FIGS. 1 and 2, the contact elements 40 are rollers that are rotatably mounted to the respective support arms 32, 34. Though not readily seen in the Figures, the rollers 40 are preferably spring-loaded, so as to facilitate compliance of the rollers 40 relative to slight constructional variations in different film fames 14. Alternatively, the contact elements 40 can assume other forms that provide a relatively planar surface for support an underside of the film frame 14 at an outer periphery thereof. For example, the contact elements can be sliders, compliant material bodies, etc.

Accordingly, the invention as described above and understood by one of skill in the art is simplified, provides an effective, safe, inexpensive, and efficient device, system and process which achieves all the enumerated objectives, provides for eliminating difficulties encountered with prior devices, systems and processes, and solves problems and obtains new results in the art.

In the foregoing description, certain terms have been used for brevity, clearness and understanding; but no unnecessary limitations are to be implied therefrom beyond the requirement of the prior art, because such terms are used for descriptive purposes and are intended to be broadly construed.

Moreover, the invention's description and illustration is by way of example, and the invention's scope is not limited to the exact details shown or described.

Having now described the features, discoveries and principles of the invention, the manner in which it is constructed and used, the characteristics of the construction, and the advantageous, new and useful results obtained; the new and useful structures, devices, elements, arrangements, parts and combinations, are set forth in the appended claims.

What is claimed is:

1. A film frame handling station including:
a load port;
a cassette selectively loaded upon the load port whereby the cassette has a plurality of slots for selectively maintaining one or more film frames therein;
a robot end effector for selectively grabbing a selected film frame from within the cassette for processing, or selectively returning a film frame after processing back to the cassette; and
a frame support adapted to be vertically adjustable for alignment with a select slot in the cassette for film frame removal or insertion, the frame support including a plurality of horizontally adjustable contact elements.

2. The film frame handling station of claim 1, wherein the frame support includes a Y-shaped body.

3. The film frame handling station of claim 1, wherein the frame support includes a base arm and opposing support arms extending from the base arm.

4. The film frame handling station of claim 3, wherein each of the support arms includes at least one of the contact elements at a top thereof.

5. The film frame handling station of claim 4, wherein each of the support arms maintains a plurality of the contact elements.

6. The film frame handling station of claim 4, wherein the frame support is configured such that the contact elements are horizontally moveable relative to the base arm.

7. The film frame handling station of claim 6, further including at least one actuator for horizontally moving the contact elements relative to the base arm.

8. The film frame handling station of claim 1, wherein each of the plurality of contact elements includes a roller.

9. The film frame handling station of claim 8, wherein each of the rollers is spring-loaded.

10. A method of handling a film frame maintaining a wafer relative to a cassette having a slot for selectively maintaining the film frame, the method comprising:
providing a handling system including a load port, a robot end effector, and a vertically adjustable frame support having a plurality of contact elements;
placing the cassette on to the load port;
engaging a forward edge of the film frame with the end effector;
supporting a bottom of the film frame along an outer region thereof with the contact elements; and
moving the film frame relative to a slot in the cassette via movement of the end effector and the frame support.

11. The method of claim 10, further comprising:
determining a diameter of the film frame; and
horizontally positioning the contact elements based upon the determined diameter.

12. The method of claim 11, wherein horizontally positioning the contact elements includes programming an actuator connected to a support otherwise maintaining the contact elements.

13. The method of claim 10, further comprising:
determining a first diameter of a first film frame;
horizontally positioning the contact elements based upon the determined first diameter;
processing the first film frame;
determining a second diameter of a second film frame, the second diameter being different from the first diameter; and
horizontally re-positioning the contact elements based upon the determined second diameter.

14. The method of claim 10, wherein moving the frame support relative to the cassette slot includes moving the film frame away from the cassette slot.

15. The method of claim 10, wherein moving the frame support relative to the cassette slot includes moving the film frame toward the cassette slot.

16. The method of claim 10, wherein supporting a bottom of the film frame includes engaging the bottom of the film frame such that the film frame is moveable relative to the contact elements.

17. The method of claim 16, wherein each of the contact elements is a roller.
